(19) United States
(12) Patent Application Publication
(10) Pub. No.: US 2026/0285494 A1
(43) Pub. Date: Sep. 24, 2026

(54) LIFTING APPARATUS FOR AERIAL VEHICLE

(71) Applicant: CHANGINAVIATION CO., LTD., Incheon (KR)

(72) Inventors: Chang Mo MOON, Seoul (KR); Ji Ho MOON, Seoul (KR); Jon AHN, Seoul (KR)

(21) Appl. No.: 19/477,430

(22) PCT Filed: Jul. 5, 2024
(86) PCT No.: PCT/KR2024/009557

§ 371 Date: Oct. 21, 2025

(30) Foreign Application Priority Data
Jul. 11, 2023 (KR) 10-2023-0089872

(51) Int. Cl. B64D 33/04; B64C 15/14; B64C 29/00

(52) U.S. Cl. CPC B64D 33/04; B64C 15/14; B64C 29/005; B64C 29/0058; B64C 29/0091

(57) ABSTRACT

A lifting apparatus for an aircraft, including: an inlet duct installed in the aircraft to guide an inflow and a flow of air from the atmosphere; a jet stream generating apparatus for generating a high-speed jet stream using the air introduced through the inlet duct; a duct arranged such that an outlet direction of the jet stream is directed toward a lower side of the aircraft; a first vane installed at an outlet of the duct to adjust a jetting direction of the jet stream; and a second vane installed at an inlet of the duct to help the jet stream flow smoothly along a curved surface where centrifugal force is generated.

### TECHNICAL FIELD

The present invention relates to a lifting apparatus for an aircraft to generate lift in an aircraft.

### BACKGROUND ART

A fixed-wing aircraft generates lift by a static pressure difference resulting from a difference in the speed of air flowing over the upper and lower surfaces of an airfoil-shaped wing, and requires a runway for takeoff.

A rotary-wing aircraft generates lift by the thrust created as blades with an airfoil shape rotate, causing air to flow from an upper surface to a lower surface. A rotary-wing aircraft requires a tail rotor to counteract the torque generated by the rotation of large blades, and its vulnerability to strong gusts during vertical takeoff and landing at the low speed of the air ejected through the blades becomes a primary cause of crash accidents.

Additionally, Patent Document 1 discloses a technology for obtaining lift by flowing a jet stream over a fuselage surface or a wing using the Coanda effect.

In an experiment to verify the practical application of Patent Document 1, it was confirmed that when a near-sonic jet stream of compressed air from an air compressor is flowed through a 0.010 mm-gap nozzle onto a curved surface with a diameter as small as 20 mm, a significant level of lift is generated by the centrifugal force created as the jet stream turns along the curved surface while flowing without separation.

However, commercializing Patent Document 1 requires increasing the diameter of the curved surface and the nozzle gap. However, when a high-speed jet stream near the speed of sound flows along a curved surface with a large diameter, the centrifugal force increases, and according to the Coanda effect, the jet stream flows along the curved surface. The force of the jet stream acts more strongly than the viscous force with the curved surface, causing a separation phenomenon of the jet stream and thus limiting its practical application.

Furthermore, according to Computational Fluid Dynamics (CFD) analysis, there is a problem in that when a strong external wind is applied to a jet stream flowing along a curved surface, the separation phenomenon of the jet stream easily occurs.

### RELATED ART DOCUMENTS

### Patent Documents

(Patent Document 1) KR 10-2048412 B1

(Patent Document 2) EP 2 451 706 B1

(Patent Document 3) KR 10-2020-0034987 A

### DISCLOSURE

### Technical Problem

Therefore, the present invention has been made in view of the above problems, and it is one object of the present invention to provide a lifting apparatus for an aircraft that dramatically improves the low reliability and safety of helicopters or multicopters using existing vertical takeoff and landing lift-generating apparatuses, which arise from a high incidence of accidents caused by unexpected gusts and strong winds during vertical takeoff and landing and transition flight.

It is another object of the present invention to provide a lifting apparatus for an aircraft that significantly improves the energy efficiency of the entire flight by also considering the energy efficiency during cruising.

It is yet another object of the present invention to a lifting apparatus for an aircraft which allows a VTOL aircraft equipped with the lift-generating apparatus to become a vertical takeoff and landing aircraft that can have the advantages of both existing fixed-wing and rotary-wing aircrafts, and which enables stable attitude control during the vertical takeoff and landing and transition flight process by arranging a number of lift-generating apparatuses of various shapes and sizes on the aircraft.

### Technical Solution

In accordance with an aspect of the present invention, the above and other objects can be accomplished by the provision of a lifting apparatus for an aircraft, including: an inlet duct 30 installed in the aircraft 1 to guide an inflow and a flow of air from the atmosphere; a jet stream generating apparatus 20 for generating a high-speed jet stream using the air introduced through the inlet duct 30; a duct 10 arranged such that an outlet direction of the jet stream is directed toward a lower side of the aircraft 1; and a first vane 12 installed at an outlet of the duct 10 to adjust a jetting direction of the jet stream.

In addition, in the lifting apparatus for an aircraft according to an embodiment of the present invention, the inlet duct 30 may allow atmospheric air to be introduced in a vertically downward direction, regardless of an angle a° formed by an inlet and an outlet.

In addition, atmospheric air may be introduced in a vertically downward direction so that a suction force, generated by a difference in static pressure that is lowered at an upper surface of a lip 35 of the inlet duct 30, results in an increase in lift.

In addition, atmospheric air may be introduced from a lateral horizontal direction to prevent the suction force, generated by a difference in static pressure that is lowered at the upper surface of the lip of the inlet duct 30, from causing a loss of lift.

In addition, in the duct 10 of the lifting apparatus for an aircraft according to an embodiment of the present invention, an angle a° formed by the inlet and the outlet may be from 0° to 180°.

In addition, in the duct 10 of the lifting apparatus for an aircraft according to an embodiment of the present invention, an angle a° formed by the inlet and the outlet may be from 0° to 180°. In addition, in the lifting apparatus for an aircraft according to an embodiment of the present invention, a gap t may be formed at a portion where an inlet of the duct 10 and the jet stream generating apparatus 20 are connected, and external air not passing through the jet stream generating apparatus 20 may be introduced into the duct 10 through the gap t.

In addition, the duct 10 of the lifting apparatus for an aircraft according to an embodiment of the present invention may have a horseshoe-shaped (∩) cross-section, prevent a jet stream discharged from the jet stream generating apparatus 20 from diffusing to an outside, prevent the jet stream from being disturbed by wind and gusts from outside the aircraft, and allow external air to flow in freely according to a Coanda effect.

In addition, in the duct 10 of the lifting apparatus for an aircraft according to an embodiment of the present invention, the jet stream discharged from the jet stream generating apparatus 20 may flow smoothly along the curved surface where centrifugal force is generated, by being guided by the vane 13, which is installed to extend from a predetermined straight section 15 to a position where a lift-direction component of force due to centrifugal force acts significantly, before the jet stream flows along the curved surface.

In addition, in the lifting apparatus for an aircraft according to an embodiment of the present invention, the duct 10 or the inlet duct 30 may have concave dimple shapes with a diameter of 1 mm or less formed on an inner surface thereof, and the Dimple shapes may reduce friction loss of air or a jet stream with the duct 10 or the inlet duct 30. Preferably, considering the speed of the jet stream ranging from 252 km/h to 432 km/h, the dimple size may have a diameter of about 1 to 4 mm, and the depth of the dimple may be about 0.15 mm.

In addition, in the lifting apparatus for an aircraft according to an embodiment of the present invention, the attitude of the aircraft may be controlled by controlling an output of the jet stream generating apparatus 20 or an angle of the first vane 12.

In addition, in the lifting apparatus for an aircraft according to an embodiment of the present invention, the duct 10 may include a first section 10a and a second section 10b, wherein the first section 10a has a gently curved shape with a closed circular cross-section, and the second section 10b has a gently curved shape with a cross-section that is open in a downward direction and widens toward an outlet.

Further, in the lifting apparatus for an aircraft according to an embodiment of the present invention, the duct 10 may have a cross-sectional area that gradually increases from an inlet to an outlet and may be bent with a gentle curvature to form a spiral.

Specific details of other embodiments are included in the detailed description and the accompanying drawings.

### Advantageous Effects

A lifting apparatus for an aircraft according to an embodiment of the present invention can operate during the vertical takeoff and landing and transition flight of a vertical takeoff and landing aircraft, even in situations with strong winds and gusts, and by using a fan connected to a BLDC motor or turbo shaft engine rotating at a high speed of 50,000 RPM as a jet stream generating apparatus, the required lift can be stably obtained through the centrifugal force generated inside the duct and the thrust of the jet stream discharged at a high speed of approximately 50 m/s or more at the outlet.

Furthermore, the lifting apparatus for an aircraft according to an embodiment of the present invention can also perform attitude control simultaneously by appropriately arranging a number of lift-generating apparatus of various shapes and sizes on the aircraft, and referring to the fact that the World Meteorological Organization defines the average maximum speed of term gusts as 10 to 15 knots, strong gusts as 15 to 25 knots, and violent gusts as exceeding 25 knots (12.90 m/s), a jet stream ejection speed of 50 m/sec or more at the outlet of the duct enables stable attitude control during vertical takeoff and landing and transition flight even in strong gusts.

Meanwhile, directly jetting a jet stream in a vertically downward direction can cause a vortex ring, but the lifting apparatus for an aircraft according to an embodiment of the present invention is fundamentally unable to generate a vortex ring because the positions of the air inlet and outlet of the lift-generating apparatus are separated, so there is no need to worry about energy loss due to the vortex ring.

Through experiments using a commercial Electric Ducted Fan (EDF) and a simple experimental setup without an inlet duct, the lift of the lifting apparatus for an aircraft according to an embodiment of the present invention is 1.99 kgf/kw, and considering the improvement of an optimized jet stream generating apparatus and the addition of an inlet duct to enable air intake from the top, the expected lift efficiency can be anticipated to be at least 3.0 kgf/kw or more.

Referring to the Hover Vertical Lift Efficiency (source: Wikimedia Commons), the lifting apparatus for an aircraft according to an embodiment of the present invention can achieve an effect improved by at least 50% or more than the maximum lift of an existing lift-fan, which is 2.1 kgf/kw, and this level of lift is equivalent to that of a tilt rotor.

In addition, in the lifting apparatus for an aircraft according to an embodiment of the present invention, the lift obtained through experiments using an experimental model without an inlet duct is 1.99 kgf/kw, which is lower than that of an existing helicopter, but considering that it has been confirmed that there is sufficient room for improvement through the improvement of the jet stream generating apparatus, the addition of an inlet duct to the lift-generating apparatus, and the optimized design of the duct, a lift efficiency of at least 3.0 kgf/kw or more is expected.

In addition, in the lifting apparatus for an aircraft according to an embodiment of the present invention, since fans, blades, propellers, etc., required for vertical takeoff and landing are not exposed to the outside but are mounted inside the aircraft, there is an effect of relatively small air resistance during cruise flight.

Furthermore, the lifting apparatus for an aircraft according to an embodiment of the present invention has much higher overall energy efficiency than existing rotary-wing type vertical takeoff and landing aircraft, and to be more specific, if aircraft are listed in order of lift efficiency from smallest to largest, they are direct lift aircraft, lift fan aircraft, tilt wing aircraft, tilt rotor aircraft, and helicopters, and an aircraft (lift & cruise type) equipped the lifting apparatus for an aircraft according to an embodiment of the present invention can be estimated to be at the same level as a tilt rotor aircraft, and when considering the energy efficiency during cruising, the energy efficiency of the aircraft equipped with the lifting apparatus for an aircraft according to an embodiment of the present invention (lift & cruise type) will be by far the best.

Since a turboshaft engine can also be used as the power source for the jet stream generating apparatus in addition to an electric motor, it can be utilized as a lift-generating apparatus for VTOL of small to large vertical takeoff and landing aircrafts, and it can replace the lift-generating apparatus of existing rotary-wing concept VTOL aircrafts, which have a high accident risk due to their vulnerability to strong winds and gusts during vertical takeoff and landing.

The lifting apparatus for an aircraft according to an embodiment of the present invention is changed to a method of flowing a subsonic jet stream over a concave curved surface with an appropriate radius of curvature that can minimize drag. It was confirmed that lift is generated by the sum of the vertical components of the generated centrifugal force and the differences between the static pressure inside the lift-generating apparatus and the atmospheric pressure outside the duct, and the sum of the thrust generated by the action-reaction that occurs when the jet stream is ejected vertically downward at the outlet of the lift-generating apparatus. At this time, as the ejection speed is much higher (approximately 50 m/s or more) than the typically occurring strong gust speed (a speed of about 13 m/s or more), it has strong resistance to disturbances such as strong winds or gusts. Thus, considering that the main cause of accidents for conventional rotary-wing aircraft is their weakness to disturbances during the vertical takeoff and landing and transition flight process, the lift-generating apparatus has the effect of being able to have high reliability and safety while having the advantages of fixed-wing and rotary-wing aircraft.

In addition, the lifting apparatus for an aircraft according to an embodiment of the present invention has confirmed that the suction force at the inlet of the lift-generating apparatus is at a non-negligibly high level compared to the thrust by action-reaction at the outlet, and thus has the effect of further increasing lift by installing an inlet duct to allow air to flow in a vertically downward direction as much as possible at the inlet of the lift-generating apparatus while minimizing friction loss.

### DESCRIPTION OF DRAWINGS

FIGS. 1A to 1J are diagrams for explaining a lifting apparatus for an aircraft according to an embodiment of the present invention.

FIG. 2 is a diagram for explaining an example in which the lifting apparatus for an aircraft according to an embodiment of the present invention is applied to an aircraft.

FIG. 3 is a table for explaining the operational effects of the lift-generating apparatus of the aircraft according to an embodiment of the present invention.

FIG. 4 is a graph showing the table of FIG. 3 in an easy-to-understand manner.

FIG. 5 is a table for explaining the operational effects of the lifting apparatus for an aircraft according to an embodiment of the present invention with a gap formed therein.

FIG. 6 is a graph showing the table of FIG. 5 in an easy-to-understand manner.

FIGS. 7 and 8 are a drawing and table showing the results of measuring and calculating the trend of change in the lift value of the vertical component, which reflects the centrifugal force and the projected area, while increasing the angle of a 180° rotation angle device of the apparatus according to the present invention in units of 10 to 15°.

FIG. 9 is a diagram illustrating a lifting apparatus for an aircraft according to another embodiment of the present invention.

FIG. 10 is a diagram illustrating a lifting apparatus for an aircraft according to still another embodiment of the present invention.

FIGS. 11A and 11B are diagrams illustrating the position of the lifting apparatus according to an embodiment of the present invention mounted on an aircraft when the lifting apparatus is used as an auxiliary lift apparatus for attitude control during vertical takeoff and landing and transition flight.

### BEST MODE FOR CARRYING OUT THE INVENTION

The advantages and features of the present invention and the method of achieving them will become apparent with reference to the embodiments described in detail below together with the accompanying drawings.

Hereinafter, an embodiment of the present invention will be described in detail with reference to the accompanying drawings. The embodiment described below is provided as an example to help understand the present invention, and it should be understood that the present invention can be implemented in various ways different from the embodiment described herein. However, in the following description of the present invention, a detailed description of known functions and configurations incorporated herein will be omitted when it may make the subject matter of the present invention unclear. In addition, the accompanying drawings are not drawn to their actual scales and some components may be drawn with exaggerated sizes to help understand the invention.

Meanwhile, the terms described below are terms established in consideration of their functions in the present invention and thus may vary depending on the intention of a producer or custom. Accordingly, the definitions of the terms should be understood on the basis of the entire description of the present specification.

Throughout the specification, like reference numerals denote like elements.

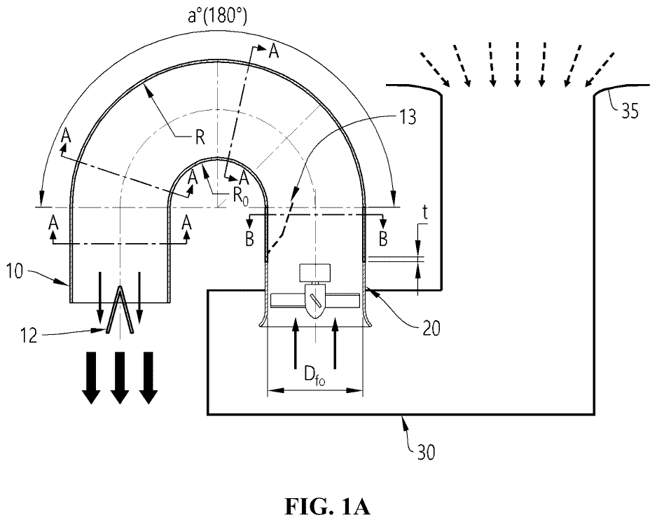

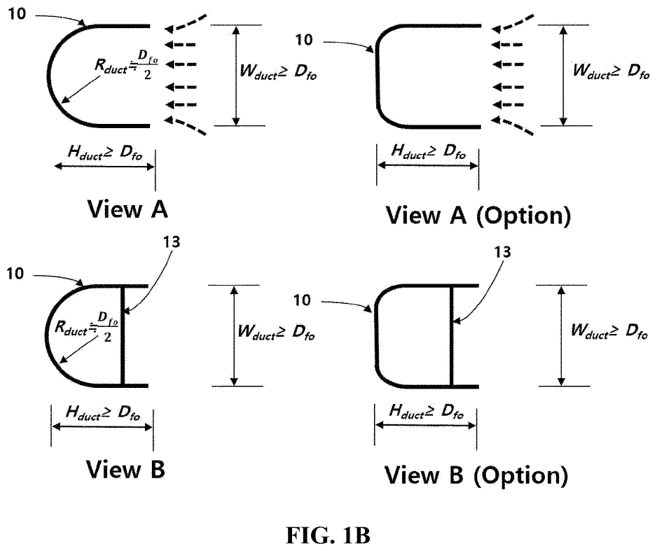

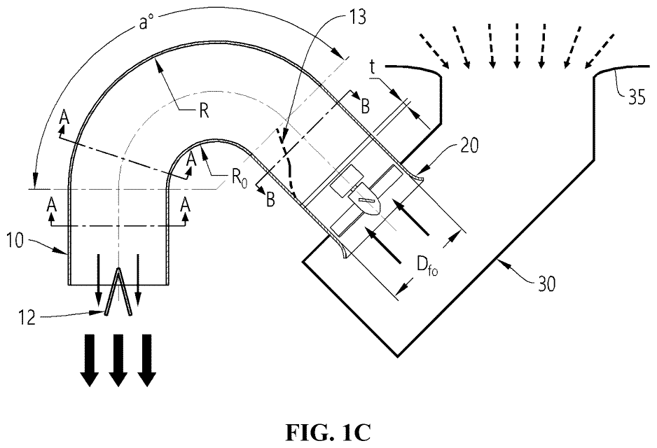

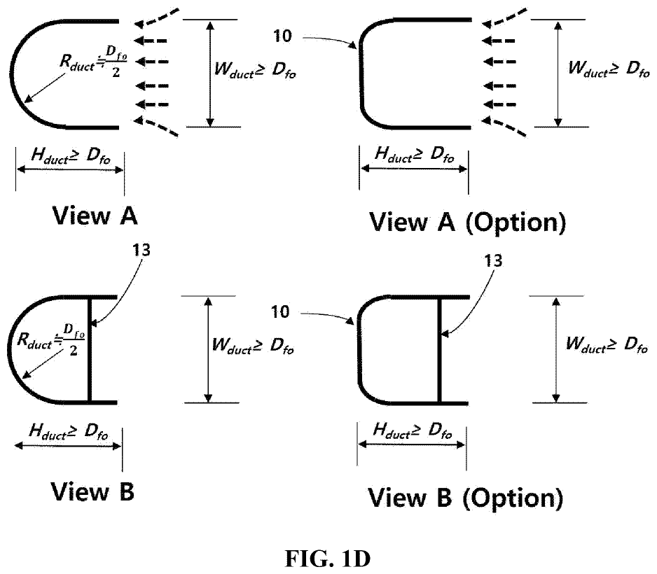

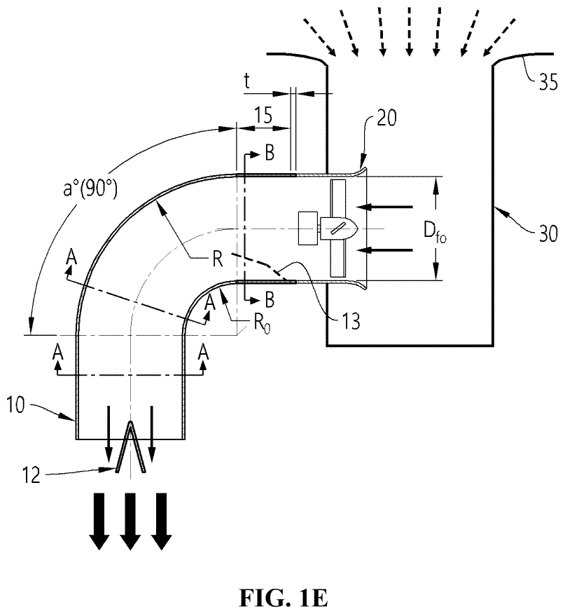

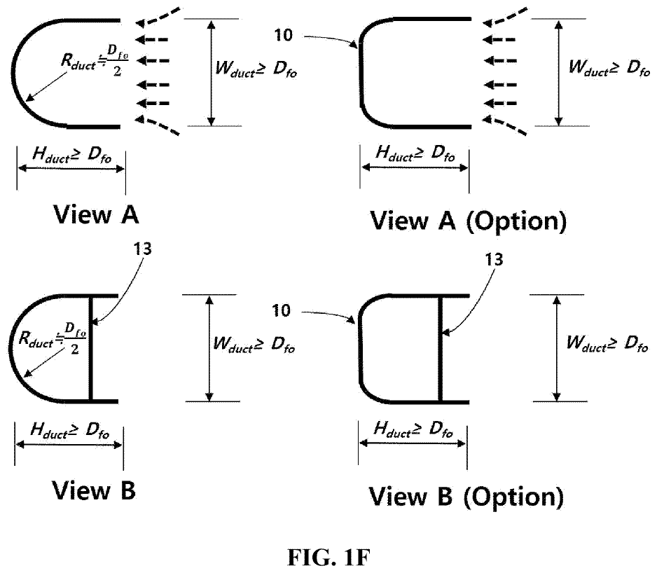

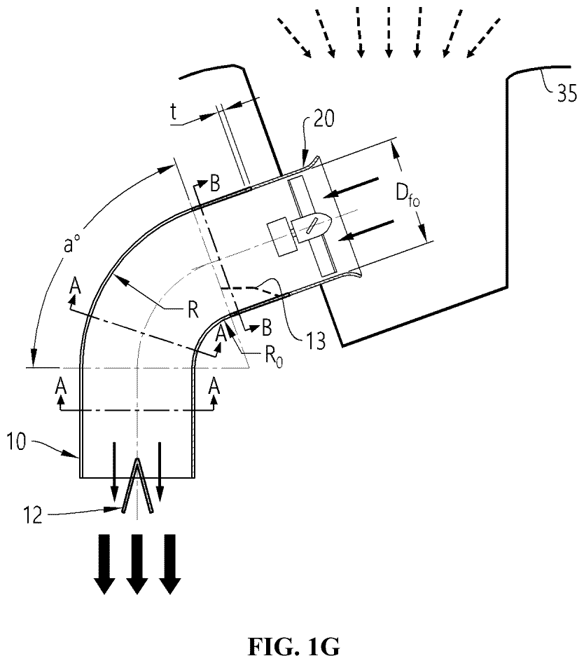

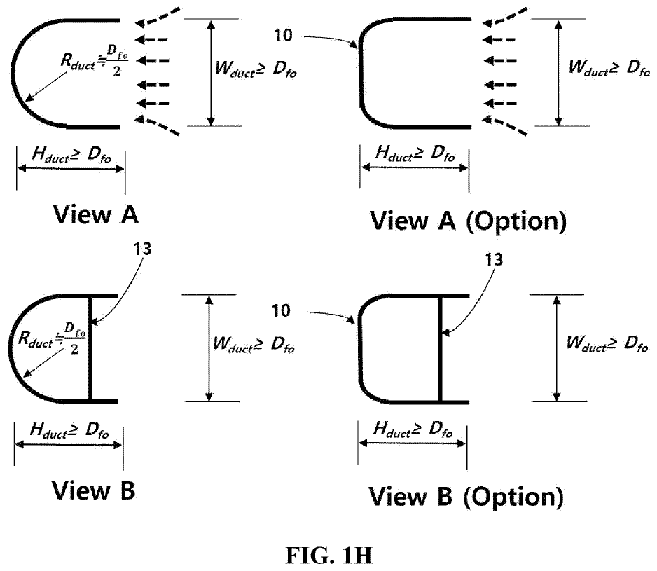

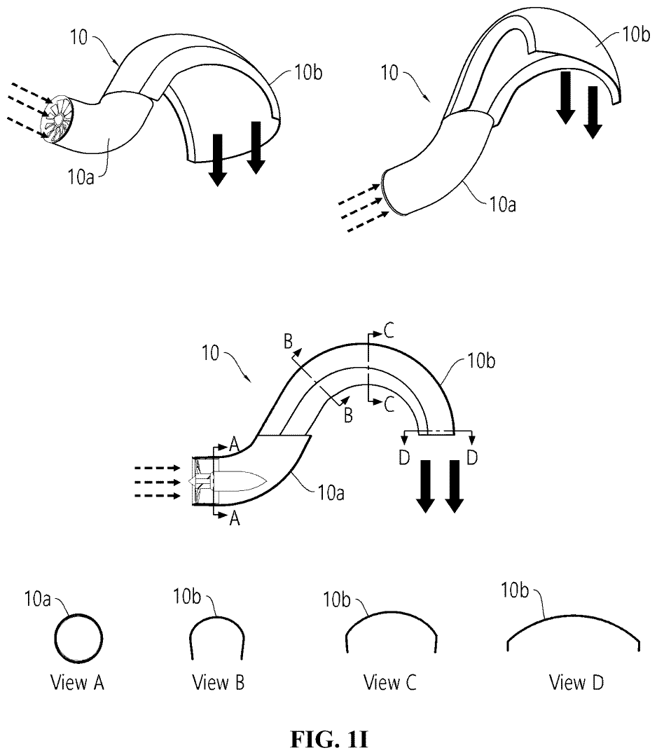

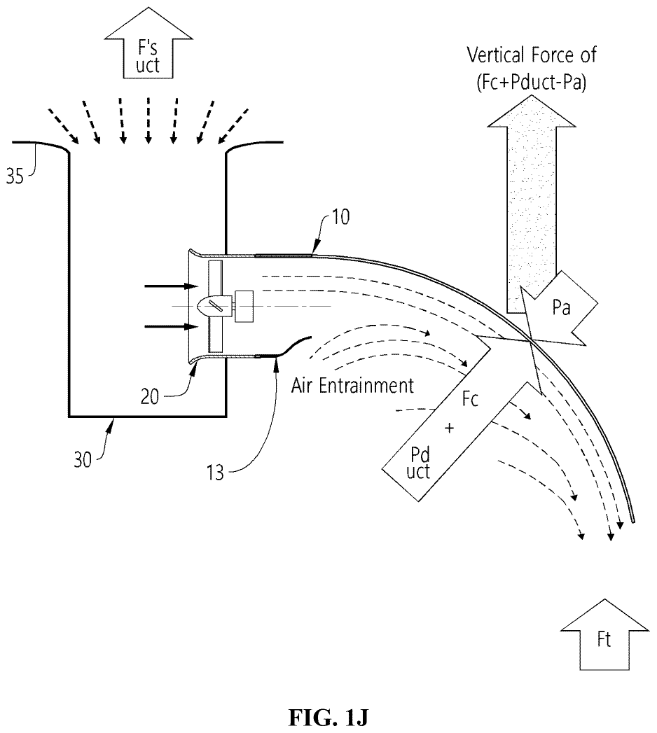

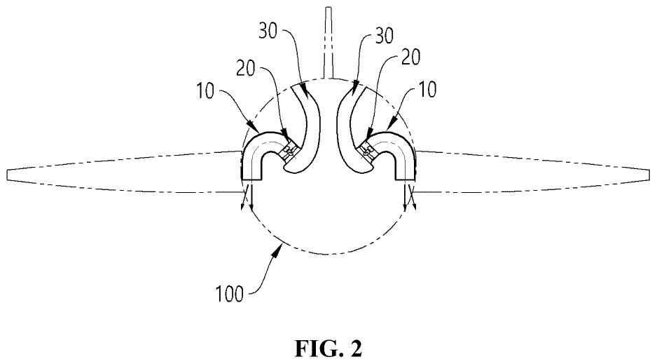

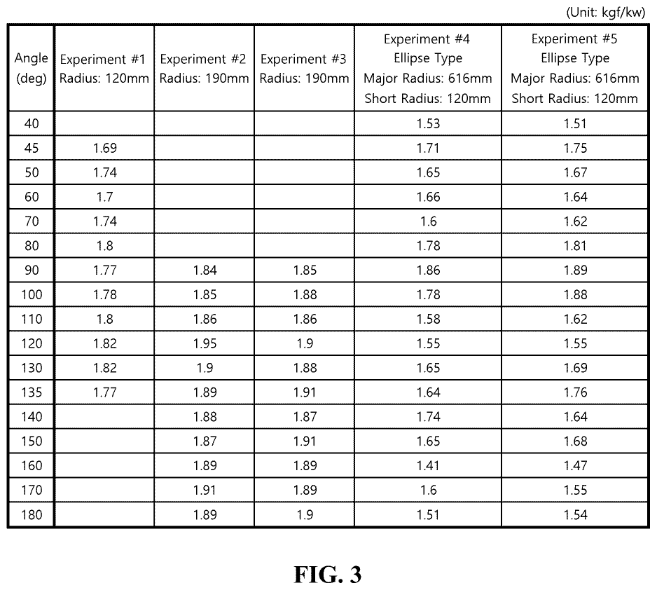

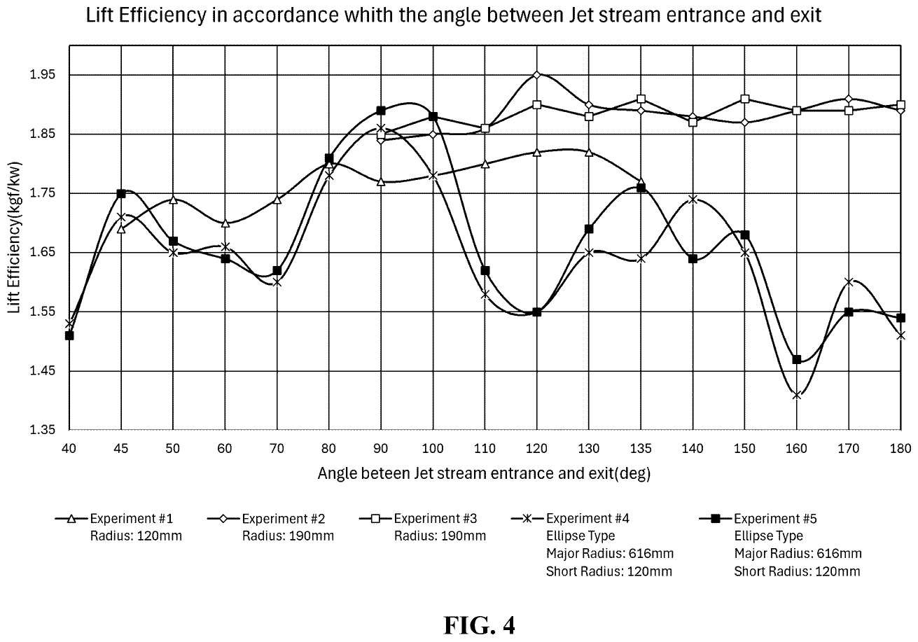

A lifting apparatus for an aircraft according to an embodiment of the present invention will be described with reference to the accompanying drawings. FIGS. 1A to 1J are diagrams for explaining a lifting apparatus for an aircraft according to an embodiment of the present invention. FIG. 2 is a diagram for explaining an example in which the lifting apparatus for an aircraft according to an embodiment of the present invention is applied to an aircraft. FIG. 3 is a table for explaining the operational effects of the lift-generating apparatus of the aircraft according to an embodiment of the present invention. FIG. 4 is a graph showing the table of FIG. 3 in an easy-to-understand manner.

### DESCRIPTION OF SYMBOLS

10: duct
12, 13: vane
15: straight section of duct 10, installed to reduce inner cross-sectional area of duct for vane 13 to effectively generate centrifugal force, and to maintain constant centrifugal force
20: jet stream generating apparatus
30: inlet duct
35: lip
100: aircraft
a°: angle between inlet and outlet of the jet stream
R: radius of outer inner wall of duct
R₀: inner radius of duct
H_{duct}: inner height of curved surface portion of duct
R_{duct}: inner radius of curved surface portion of duct
W_{duct}: inner width of straight portion of duct
D_{fo}: outlet diameter of jet stream generating apparatus
t: gap formed between duct and airflow injection apparatus
P_{duct}: static pressure inside duct
Pₐ: atmospheric pressure
F_{suct}: suction force at inlet duct entrance
F′_{suct}: vertical action/reaction force of suction force at inlet duct entrance
Lift: total lift
L_{duct}: lift generated inside duct
Fₜ: action/reaction force generated by vertical thrust generated at duct outlet

### MODE FOR CARRYING OUT THE INVENTION

A lifting apparatus for an aircraft according to an embodiment of the present invention may include a duct 10, a jet stream generating apparatus 20 and an inlet duct 30.

The duct 10 is installed in an aircraft 1 to guide the flow of a jet stream, and is arranged such that an outlet direction of the jet stream is directed toward a lower side of the aircraft 1.

The jet stream generating apparatus 20 may be installed at an inlet of the duct 10, and may inject a jet stream into the duct 10 at a high speed using air introduced through the inlet duct 30.

The jet stream generating apparatus 20 may be configured as a jet fan, and the jet fan may be operated by utilizing the rotational force from the power of an electric motor, an internal combustion engine, or a jet engine, or may be replaced by a method of ejecting compressed air stored in a high-pressure compressed air tank.

The compressed air tank may compress and store air using an air compressor on the ground before flight, may operate an air compressor using electrical energy generated while the aircraft is in flight to compress and store air, and may operate an air compressor using the power of a thrust engine to compress and store air.

Referring to FIG. 1, the lifting apparatus for an aircraft according to an embodiment of the present invention may further include a vane 13. In addition, a straight portion 15 may be further provided behind the jet stream generating apparatus 20. Air sucked in through the vane 13 may adhere more closely to the apparatus of the present invention, i.e., the duct 10, as it passes therethrough. Through this, a stronger centrifugal force and a corresponding lift may be obtained. Finally, the internal static pressure may be effectively increased due to the increase in the centrifugal force.

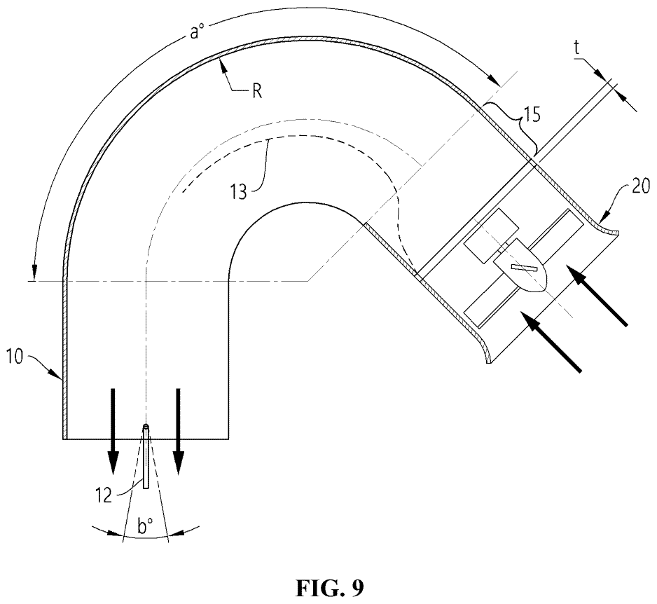

Referring to FIG. 9, the lifting apparatus for an aircraft according to an embodiment of the present invention may further include a vane 12.

The vane 12 may be installed on the outlet side of the duct 10. The attitude of the vane 12 may be adjusted to be tilted to one side or the opposite side (see b°), and the angle adjustment may be controlled by an automatic control method.

The vane 12 may be controlled such that the thrust generated at the outlet of the duct 10 is generated in a vertical direction by artificially adjusting the discharge direction of the jet stream.

In addition, the vane 12 may be provided as a fixed type in consideration of the characteristics of the duct 10, or may be used to control the attitude of the aircraft by adjusting its angle via an automatic control method during flight.

As a result, the vane 12 allows the jet stream to be discharged from the outlet of the duct 10 in a straight direction intended by the manufacturer of the aircraft, without being scattered.

That is, when the jet stream is discharged, the vane 12 allows the jet stream to be discharged directly in a vertical direction from the point of discharge without being scattered, thereby causing the thrust from action-reaction to become lift, and additionally, by allowing the vane 12 to be automatically controlled. Accordingly, the vane 12 may be used to control the attitude of the aircraft in an intended direction during vertical takeoff and landing and transition flight.

On the other hand, when the speed of the jet stream is increased, energy loss and an unacceptably high level of noise may occur due to shock wave generation inside the lift-generating apparatus, and a near-sonic jet stream may even cause shock waves. Accordingly, it is preferable to control the speed of the jet stream to a speed much lower than the speed of sound to avoid a result that degrades the lift efficiency and energy efficiency of the lift-generating apparatus.

In addition, the duct 10 may be designed to have a radius of curvature that reduces air friction loss, and may be designed to reduce energy loss and increase lift efficiency.

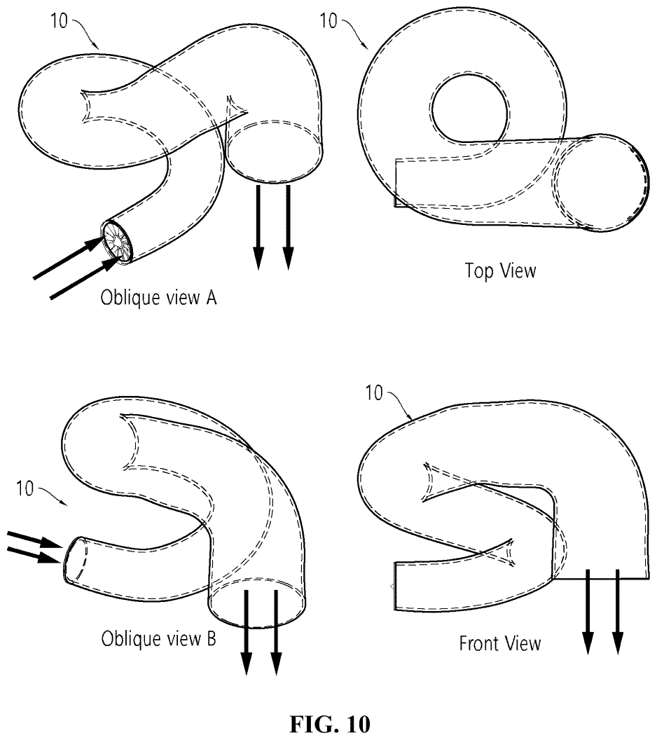

Referring to FIG. 10, in the lifting apparatus for an aircraft according to an embodiment of the present invention, the duct 10 may be provided in a spiral tube shape.

The embodiment of the duct 10 shown in FIG. 10 has a shape in which the cross-sectional area gradually increases from an inlet where the jet stream is introduced to an outlet where the jet stream is discharged, and it forms an overall gentle curved surface shape.

As a result, that is, since the duct 10 has a tubular shape that gradually increases, the effect of increasing the flow rate when the jet stream is discharged from the outlet may be expected.

In addition, by providing the duct 10 in a spiral shape with a gentle curvature, the external size of the duct 10 may be minimized, and there is an effect of occupying a minimum amount of space when the duct 10 is installed in an aircraft 100.

In addition, as shown in FIG. 2, the influence of factors such as external wind may be blocked by locating the lifting apparatus for an aircraft according to the present invention inside the aircraft. FIG. 2 only shows an embodiment of the present invention, and the arrangement of the duct 10 and an inlet duct 20 is not limited thereto.

An aircraft has a minimum flight speed set for obtaining lift, and if it flies at a speed similar to or slower than the minimum flight speed, the aircraft descends, and if it loses lift, it may stall and crash.

The lifting apparatus for an aircraft according to an embodiment of the present invention may operate during the vertical takeoff and landing and transition flight of a vertical aircraft, and may also be temporarily used as a lift assist apparatus to prevent the occurrence of a spin by proceeding at a speed lower than a stall speed due to an abnormal situation during the cruise flight of a cruise and lift type of vertical takeoff and landing aircraft.

When the lifting apparatus for an aircraft according to an embodiment of the present invention is operated, a jet stream is injected into the duct 10 from the jet stream generating apparatus 20 that uses atmospheric air introduced through the inlet duct 30.

FIG. 1i illustrates another embodiment of the duct 10, and illustrates the overall shape shown from the direction in which air is injected, the overall shape shown from the direction in which air is discharged, and a side view of the overall shape.

The duct 10 may include a first section 10a having a circular cross-sectional shape and a second section 10b with one side open.

The first section 10a of the duct 10 has an elbow shape, as shown in the front view of FIG. li, and the cross-section of the first section 10a is circular, as shown in View A of FIG. 1i.

In addition, the second section 10b of the duct 10, as shown in Views B to D of FIG. 1i, has a shape with an open bottom, and has a shape that widens as it approaches the outlet.

In the lift-generating apparatus of the present invention shown in FIG. 1i, as the jet stream passes through the first section 10a, its direction of travel changes according to the shape of the first section 10a. Next, as the jet stream passes through the second section 10b, it is discharged in a downward direction as the pressure increases.

In particular, the second section 10b is provided with an open bottom, which allows air other than the jet stream to be added, enabling more air to be discharged in a downward direction.

The total lift of this lift-generating apparatus is the sum of: the force of the vertical component of the centrifugal force Fc generated as the jet stream flows along the inside of the curved surface at the R position of the duct 10; the force of the vertical component generated by the difference between the internal static pressure P_{duct} of the duct and the external atmospheric pressure Pa; the suction force F′_{suct} generated at the vertical inlet of the inlet duct 30; and the thrust Ft generated by the action and reaction of the jet stream discharged in the downward direction of the aircraft 100 because the outlet of the duct 10 is directed toward the lower side of the aircraft 100.

Referring to FIG. 1j, Total Lift=Force of the vertical component of the centrifugal force F_{c} generated as the jet stream flows along the inside of the curved surface at the R position of the duct 10+Force of the vertical component generated by the difference between the internal static pressure P_{duct} of the duct and the external atmospheric pressure Pₐ+Suction force F′_{suct} generated at the vertical inlet of the inlet duct 30+Thrust Ft generated by the action and reaction of the jet stream discharged in the downward direction of the aircraft 100.

On the other hand, the duct 10 may be formed in a gentle curved shape as shown in FIG. 1A and FIG. 1B, or by forming dimples, as in a golf ball, on the inner surface of the curved surface of the duct 10, friction loss and any possible pressure loss occurring when the jet stream moves in the duct 10 may be reduced. The dimples may have a diameter of 1 mm or less and a concave shape. In addition, preferably, considering the speed of the jet stream ranging from 252 km/h to 432 km/h, the dimple may have a diameter of about 1 to 4 mm, and the depth of the dimple may be shaped to about 0.15 mm.

In particular, the angle a° formed by the inlet and outlet of the duct 10 may be set from 30° to 180°. However, the present invention is not limited thereto.

The angle a° will be described with reference to FIGS. 3 and 4.

FIG. 3 is a table showing lift measured from an experimental lift-generating apparatus without an inlet duct while changing the angle a°, and FIG. 4 is a graph showing the lift. More specifically, the electrical energy supplied to the jet stream generating apparatus 20 was measured, and the generated lift (kgf), relative to the power (kw) inputted to the lift-generating apparatus mounted on a simulated aircraft when the jet stream generating apparatus 20 was operated, was measured, which is shown as lift efficiency.

Lift may be the force of a vertical component generated by a centrifugal force that is proportional to the mass of a jet stream flowing over a curved surface and the square of the speed of the jet stream, and inversely proportional to the radius of curvature of the jet stream flowing over the curved surface.

In addition, the lift-generating apparatus for an aircraft according to an embodiment of the present invention may uniquely form the configuration of the duct 10 to effectively generate lift.

The duct 10 may have a single value for the radius of curvature R that allows the angular velocity of the jet stream to flow uniformly at the same angular position when flowing over a curved surface while the jet stream passes through the duct 10, and may also have multiple radii of curvature and centers in an elliptical shape.

The cross-sectional shape of the duct may be a horseshoe shape (∩) with rounded corners, the position of the inlet may be vertically upward from a horizontal position, and the outlet may be arranged in a vertically downward direction, so that the angle a° formed by the inlet and outlet may be determined from 0° to 180°. However, it is not limited to this.

In addition, the cross-sectional shape of the inlet duct 30 may be gradually changed to minimize energy loss due to resistance and friction while atmospheric air is introduced through the inlet duct 30 and flows into the jet stream generating apparatus 20, and it is preferable to form it in a streamlined shape, and it may be designed with care such that centrifugal force in the opposite direction of lift does not occur.

The cross-section of the duct 10 has one side open, i.e., a horseshoe shape (∩), so that when the jet stream flows along the curved surface, external gas that does not pass through the jet stream generating apparatus 20 may be introduced inward according to the Coanda effect.

The inner surface of the duct 10 may be formed with small, concave dimples, like the surface of a golf ball. The dimples may reduce frictional resistance when the jet stream moves in the duct 10.

In addition, in the lift-generating apparatus for an aircraft according to an embodiment of the present invention, a gap t is formed at a portion where the inlet of the duct 10 and the airflow injection apparatus 20 are connected, and external gas that does not pass through the jet stream generating apparatus 20 is introduced into the duct 10 through the gap t according to the Coanda effect, and an effect of reducing the speed of the high-speed jet stream to an appropriate level may be obtained.

In addition, the lift-generating apparatus for an aircraft according to an embodiment of the present invention may include the vane 12 at the outlet side of the duct 10 to obtain thrust, which is generated by the action-reaction of the jet stream discharged into the atmosphere in the vertical direction, in a vertical direction.

The vane 12 may be arranged obliquely to be tilted to one side or the opposite side, and its attitude may be controlled to change the tilt angle.

### Experiment 1

In Experiment 1, the radius R of the outer wall of the duct 10 was set to 120 mm and the angle a° between the inlet and outlet was set to a range of from 45 degrees to 135 degrees to measure the lift efficiency (kgf/kw).

According to the results of Experiment 1, when the angle a° was between 130° and 135°, the results were favorable and the attitude of the simulated aircraft was stably controlled.

On the other hand, in Experiment 1, when the angle was less than 130° or greater than 135°, the attitude of the simulated aircraft was observed to be more shaky or less stable than when the angle a° was between 130° and 135°, even if an appropriate lift was measured.

### Experiment 2

In Experiment 2, the radius R of the outer wall of the duct 10 was set to 190 mm and the angle a° between the inlet and the outlet was set to a range from 90 degrees to 180 degrees to measure the lift (kgf/kw).

According to the results of Experiment 2, when the angle a°was between 120° and 135°, the results were favorable and the attitude of the simulated aircraft was stably controlled.

On the other hand, in Experiment 2, when the angle was less than 120° or greater than 135°, the attitude of the simulated aircraft was observed to be more shaky or less stable than when the angle a° was between 120° and 135°, even if an appropriate lift was measured.

### Experiment 3

In Experiment 3, the lift (kgf/kw) was measured by repeating the experiment under the same conditions as Experiment 2.

According to the results of Experiment 3, when the angle a° was between 120° and 135°, the results were favorable and the attitude of the simulated aircraft was stably controlled, similar to Experiment 2.

On the other hand, in Experiment 3, when the angle was less than 120° or greater than 135°, the attitude of the simulated aircraft was observed to be more shaky or less stable than when the angle a° was between 120° and 135°, even if an appropriate lift was measured.

### Experiment 4

In Experiment 4, to measure the lift (kgf/kw), the inner wall of the duct at the R position of the duct 10 was formed into an elliptical shape, the elliptical shape was set to have a major axis of 1232 mm and a minor axis of 240 mm, and the angle a° between the inlet and outlet was set to a range from 40 degrees to 180 degrees.

According to the results of Experiment 4, when the angle a° was between 130° and 135°, the results were favorable and the attitude of the simulated aircraft was stably controlled.

On the other hand, when the angle in Experiment 4 was less than 120° or greater than 135°, the attitude of the simulated aircraft was observed to be more shaky or less stable than when the angle a° was between 130° and 135°, even if an appropriate lift was measured.

### Experiment 5

In Experiment 5, the lift (kgf/kw) was measured by repeating the experiment under the same conditions as Experiment 4.

According to the results of Experiment 5, when the angle a° was between 130° and 135°, the results were favorable and the attitude of the simulated aircraft was stably controlled, similar to Experiment 4.

On the other hand, when the angle in Experiment 5 was less than 120° or greater than 135°, the attitude of the simulated aircraft was observed to be more shaky or less stable than when the angle a° was between 130° and 135°, even if an appropriate lift was measured.

Therefore, it can be seen that when the angle a° formed by the inlet and outlet of the duct 10 is between 130° and 135°, the lift is favorably implemented, and the attitude of the simulated aircraft is stably controlled.

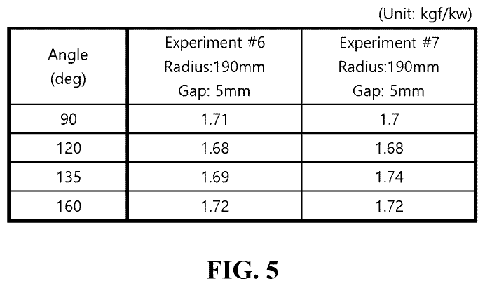

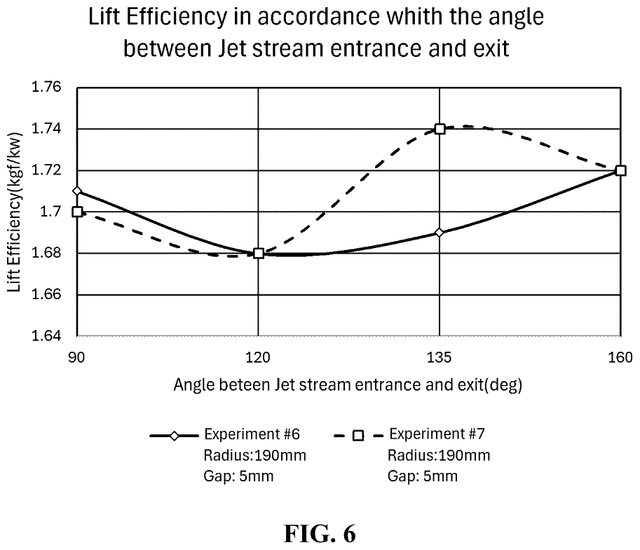

On the other hand, in the lifting apparatus for an aircraft according to an embodiment of the present invention, a gap t and the inner curved surface portion of the duct 10 may be left in an open state to the atmosphere, and it may have a shape that allows surrounding air to be introduced according to the Coanda effect, so as to supply more flow to the duct 10. This will be described with reference to FIGS. 5 and 6. FIG. 5 is a table for explaining the effect of allowing external air to be introduced into the lifting apparatus for an aircraft according to an embodiment of the present invention. FIG. 6 is a graph showing the table of FIG. 5 in an easy-to-understand manner.

The lifting apparatus for an aircraft according to an embodiment of the present invention may be formed such that a gap t at the portion where the inlet of the duct 10 and the jet stream generating apparatus 20 are connected and the inside of the duct 10 are open to allow external air to be introduced, as shown in FIG. 1.

Through the gap t and the open curved surface, external gas not passing through the jet stream generating apparatus 20 may be introduced into the duct 10, and thus, a larger gas flow rate than the flow rate of the jet stream provided from the jet stream generating apparatus 20 may flow inside the duct 10.

While the flow rate of the jet stream discharged from the duct 10 increases, the speed of the jet stream decreases due to air friction caused by the inflow of surrounding air, and there is a secondary effect of overcoming the difference in angular velocity according to the difference in radius at the same angular position. Furthermore, an effect of increasing the centrifugal force may be obtained by making the jet stream smoothly turn the curved surface of the duct 10 at almost the same angular velocity.

### Experiment 6

In Experiment 6, a gap t was formed at the portion where the inlet of the duct 10 and the airflow injection apparatus 20 are connected, and the angle a° between the inlet and outlet was set to a range from 90 degrees to 160 degrees, to measure the lift (kgf/kw).

According to the results of Experiment 6, the lift efficiency was similar at all angles a°, and the attitude of the simulated aircraft was stably controlled.

### Experiment 7

In Experiment 7, the lift (kgf/kw) was measured by repeating the experiment under the same conditions as Experiment 6.

According to the results of Experiment 7, the lift was particularly excellent at 135 degrees, and the attitude of the simulated aircraft was stably controlled.

However, the gap t at the connecting portion between the inlet of the duct 10 and the jet stream generating apparatus 20 may result in the inflow of surrounding air according to the Coanda effect, an effect of increasing the flow rate of the jet stream may be observed, and a phenomenon of decreased lift efficiency due to a decrease in the speed of the jet stream may also be observed. However, based on experimental results using the duct with the convex surface, it can be estimated that lift efficiency may be increased because a speed reduction is observed when the jet stream is ejected from the jet stream generating apparatus 20 at a pressure higher than atmospheric pressure and at a speed close to the speed of sound. On the other hand, when the inner surface at the Ro position of the duct 10 is opened to facilitate the inflow of external air, the lift efficiency is favorably implemented and the flight attitude is stabilized. In particular, the duct 10 can remarkably implement lift and lift efficiency when the angle a° formed by the inlet and outlet is 135°.

The fact that the lift is relatively higher at a position of about 135° angle than at a 90° angle in all the preceding experiments can be seen as an increase in centrifugal force with an increase in angle. After that, there is a phenomenon where the lift value temporarily decreases, and then recovers as it approaches 180°.

The phenomenon of the lift value temporarily decreasing and then recovering was confirmed to be an effect of the suction force generated at the inlet of the lift-generating apparatus reducing the lift, and an improvement effect of increasing the lift by making the inflow of external air vertically downward, or eliminating the lift reduction effect by making the inflow of external air from the side in a horizontal direction, can be seen by adding the inlet duct 30.

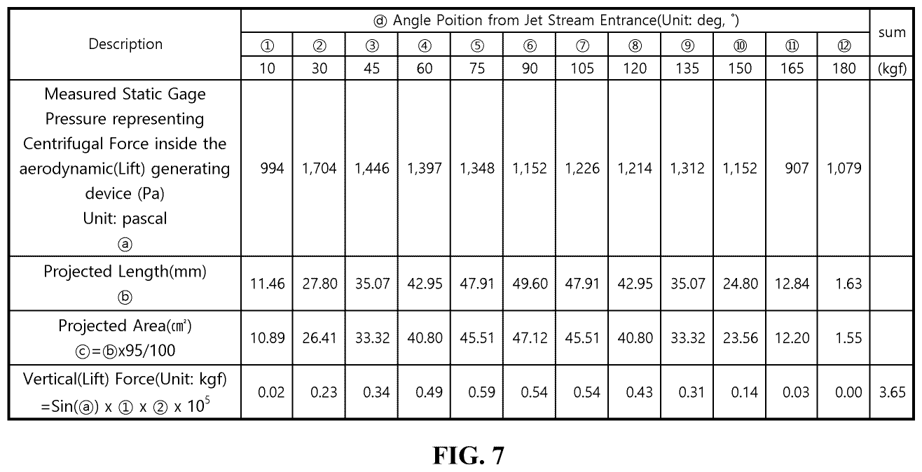

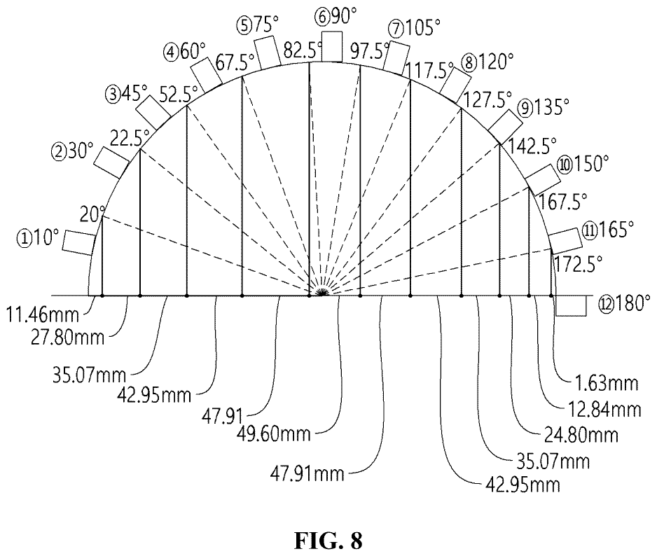

FIGS. 7 and 8 are a drawing and table showing the results of measuring and calculating the trend of change in the lift value of the vertical component, which reflects the centrifugal force and the projected area, while increasing the angle of a 180° rotation angle device of the apparatus according to the present invention in units of 10 to 15°.

More specifically, FIG. 7 is a table showing the results obtained by measuring the centrifugal force acting on the curved surface at the position of a corresponding angle at the jet stream inlet as gauge pressure, and by calculating the lift of the vertical component, when using a lift-generating apparatus experimental kit with a 180° rotation angle, a 380 mm diameter, and a 95 mm width, equipped with a 1.2 kw maximum output EDF. FIG. 8 is a drawing illustrating the length of the projected area (95 mm width x projected length) for calculating the centrifugal force measurement position mentioned in FIG. 7 and the lift of the corresponding vertical component.

The present invention may be applied to a Vertical Take-Off and Landing (VTOL) aircraft. More specifically, based on the experimental result as of the filing date, where the lift is 1.99 kgf/kw using an experimental model of a lift-generating apparatus without an inlet duct, and considering that the lift efficiency is improved by at least 50 to 100% through the addition of an inlet duct, the improvement of the jet stream generating apparatus, and the improvement of the duct design, the expected lift is predicted to reach 3.0-4.0 kgf/kw.

To operate a 4-seater small aircraft with a maximum takeoff weight of 1,600 kg as a vertical takeoff and landing aircraft, a lift of 2,013-2,684 kgf can be obtained from a jet stream generating apparatus in the form of a high-speed fan mounted on an existing 300 HP (223.71 kw) turboshaft engine (with a weight per unit of 90 kgf or less). This enables not only stable vertical takeoff and landing and transition flight, but the remaining engine thrust can also be used as thrust for forward propulsion through an additional power transmission apparatus during cruise flight.

In the process of vertical takeoff and landing and transition flight, the energy efficiency is relatively lower than that of a helicopter. However, due to its high stability and reliability, which enable vertical takeoff and landing and transition flight even in strong winds and gusts, it can be a lift-generating apparatus applicable even to large vertical takeoff and landing aircraft. Furthermore, if cruise flight is considered, the overall energy efficiency will be much higher than that of a helicopter.

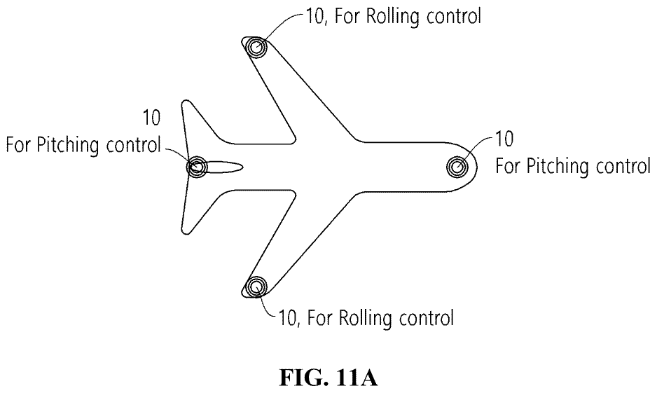

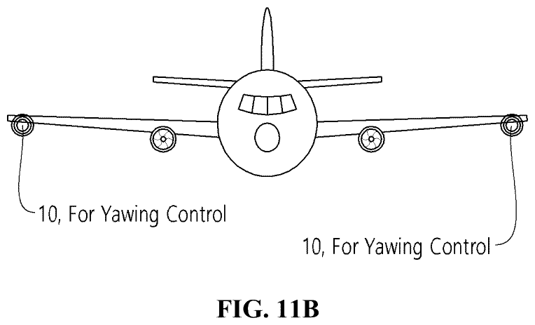

FIGS. 11A and 11B are drawings explaining an embodiment to which the present invention is applied. Referring to FIGS. 11A and 11B, the present invention may be arranged as a small lift-generating apparatus at the tip of any one or more of the fuselage, main wing, or tail wing of the aircraft for the purpose of controlling the attitude of the aircraft. The red markings may be the positions where the present invention is placed.

More specifically, a small lift-generating apparatus may be placed at a position where a large moment can be generated for attitude control of the aircraft during vertical takeoff and landing or transition flight, and may be used for attitude control. It may be hidden inside the fuselage, main wing, or tail wing to reduce air resistance during cruise flight, and then protrude as a movable type during vertical takeoff and landing and transition flight to enable it to perform attitude control functions.

According to an embodiment of the present invention, in addition to lift or thrust by action-reaction, the lift generated by the centrifugal force received by a fluid, i.e., air, from the apparatus of the present invention through the Coanda effect may be obtained inside the aircraft, so that an aircraft to which the present invention is applied has a shape that is strong against disturbances, enabling more stable flight control.

In addition, the present invention utilizes the Coanda effect in which a high-speed jet stream discharged from a jet stream generating apparatus flows along a curved surface, and utilizes the effect of increasing the flow rate as surrounding air is drawn in.

According to the present invention, a jet stream discharged from a jet stream generating apparatus generates a centrifugal force, which is proportional to the mass of the jet stream flowing along the lift-generating curved surface portion and the square of the jet stream's velocity and inversely proportional to the radius of curvature, due to the Coanda effect and the flow rate increase from the inflow of surrounding air. By the force of the vertical component of this centrifugal force, the apparatus to which the present invention is applied may be pulled upward along with it, thereby generating lift.

In addition, according to an embodiment of the present invention, since lift is generated by the centrifugal force created when a jet stream flows along a curved surface through the Coanda effect, additional lift may be obtained compared to simply jetting the jet stream directly downward.

Although the embodiments of the present invention have been described with reference to the accompanying drawings, those skilled in the art to which the present invention pertains will understand that the present invention may be embodied in other specific forms without changing its technical spirit or essential features.

Therefore, the embodiments described above should be understood as being illustrative in all respects and not restrictive, and the scope of the present invention is indicated by the claims set forth hereinafter. All changes or modified forms derived from the meaning and scope of the claims and their equivalent concepts should be interpreted as being included in the scope of the present invention.

### INDUSTRIAL APPLICABILITY

The present invention can be used in the future mobility industry, including the aviation industry.

1. A lifting apparatus for an aircraft, comprising:
an inlet duct installed in the aircraft to guide an inflow and a flow of air from the atmosphere;
a jet stream generating apparatus for generating a high-speed jet stream using the air introduced through the inlet duct;
a duct arranged such that an outlet direction of the jet stream is directed toward a lower side of the aircraft; and
a first vane installed at an outlet of the duct to adjust a jetting direction of the jet stream.

2. The lifting apparatus according to claim 1, wherein the inlet duct allows atmospheric air to be introduced in a vertically downward direction, a vertically upward direction, a laterally horizontal direction, or a laterally vertical direction, regardless of an angle a° formed by an inlet and an outlet.

3. The lifting apparatus according to claim 1, wherein a gap formed at a portion where an inlet of the duct and the jet stream generating apparatus are connected, and external air not passing through the jet stream generating apparatus is introduced into the duct through the gap.

4. The lifting apparatus according to claim 1, wherein the duct has a horseshoe-shaped cross-section, prevents a jet stream discharged from the jet stream generating apparatus from diffusing to an outside, prevents the jet stream from being disturbed by wind and gusts from outside the aircraft, and allows external air to flow in freely according to a Coanda effect.

5. The lifting apparatus according to claim 1, wherein the duct or the inlet duct has concave dimple shapes formed on an inner surface thereof, wherein the dimple shapes reduce friction loss of air or a jet stream with the duct or the inlet duct

6. The lifting apparatus according to claim 1, wherein an attitude of the aircraft is controlled by controlling an output of the jet stream generating apparatus or an angle of the first vane.

7. The lifting apparatus according to claim 1, further comprising: a second vane installed at an outlet side of the jet stream generating apparatus to adjust a direction of the jet stream.

8. The lifting apparatus according to claim 1, wherein the duct comprises a first section and a second section
wherein the first section has a gently curved shape with a closed circular cross-section, and
the second section has a gently curved shape with a cross-section that is open in a downward direction and widens toward an outlet.

9. The lifting apparatus according to claim 1, wherein the duct has a cross-sectional area that gradually increases from an inlet to an outlet and is bent with a gentle curvature to form a spiral.
